(19) United States
(12) Patent Application Publication
(10) Pub. No.: US 2003/0050163 A1
(43) Pub. Date: Mar. 13, 2003

(54) Die changer with cone hole registration system

(76) Inventor: Ronald R. Smith, Kansas City, MO (US)

Correspondence Address: Pillsbury Winthrop LLP, Intellectual Property Group, 50 Fremont Street, San Francisco, CA, 94105, US

(21) Appl. No.: 09/951,144

(22) Filed: Sep. 13, 2001

(51) Int. Cl. B31B 49/02

(52) U.S. Cl. 493/141

(57) ABSTRACT

A die changer registration system of the present invention includes a die having a holes and beveled edges and a die changer having trigger levers, trigger clamps, and a die receiving surface including pins extending therefrom. The die is registered on the die changer by fitting the pins into the die holes. Trigger levers are used to register and release the die from the die changer. Further, trigger clamps are used to hold the die within the die changer using the beveled edges. In this manner, the die changer can be used to automatically registers and changes dies without requiring “make-ready” operations.

### FIELD OF THE INVENTION

The present invention relates to a cone hole registration system for registering dies within a die changer. More particularly, the present invention is directed to a die changer with pins located therein for registering and locking dies.

### DESCRIPTION OF THE PRIOR ART

An emboss module or press is used to emboss a sheet of material such as paper, card, cardboard, plastic, etc. Such embossments on the sheet of material provide for a more artistic and visually appealing feature on the material. In most cases, artists designed the shape, size, and features of the dies that are used to emboss the material. For example, greeting cards are embossed using dies having various shapes and styles to provide consumers a wide selection of decorative features on the cards.

In most cases, the sheet of material such as paper or greeting card is positioned in between the male and female dies as the two dies are pressed together in a complementary manner to form the embossment(s) in the material. In other emboss modules, a flexible counter such as the one described in the U.S. Pat. No. 6,186,936, titled “Paper Embossing System with a Flexible Counter and Method of Embossing,” assigned to the common assignee of record, is used in lieu of the male die. In this case, the female die is pressed against the sheet of material resting on the flexible counter to form the embossment(s).

When a particular die is desired for use in the emboss module, the die is typically screwed into the module or die changer. When a different die is desired, the old die must be unscrewed, and a new die screwed in its place. As can be expected, this is very time-consuming and burdensome process.

Now, the following describes the conventional registration process for matching the emboss die to printed art based on lithography. First, the emboss die for blank emboss is positioned on the sheet of material by comparing the die to a template of printed stock or transparency. The die is mated to the printed stock by stencil cut out of the art that is laid over the die image. Alternatively, the die is mated to the printed transparency that is laid over the die image. Next, the mated die and the template are secured in position on the emboss module with the counter mated die half sandwiched to the die. The emboss module is closed to the shut height of the module, and the counter half is transferred to the press frame half. The counter mated die half and emboss die can be locked and transferred to the emboss module and frame half by glue, clamps, and keys. The sheet of material is located by guide and gripper devices passing through the emboss module at open and shut heights that are timed to pick-up and place the sheet of material. The material pick and place method can lead the mated die and template for positioning or follow the mated die and template for material positioning depending on the type of emboss module and material handling system.

In the above described process, an operator is generally required to manually replace and re-position the dies whenever a different embossment shape or style is desired on the material. In this case, the emboss module is turned off, while the operator replaces, re-aligns, re-positions, etc., the different die within the module or die changer. In other words, the operator manually performs “make-ready” operations such as stopping, changing, moving, positioning, etc., the die.

Another drawback is that there is no automatic registering method currently available for registering dies in the die changers. The dies are typically registered manually into the die changers using screws, flat heads, bunter posts, quoin keys, printer keys, and the like.

### SUMMARY OF THE INVENTION

In view of the above described problems of the prior art, it is an object of the present invention to provide a more efficient and scalable die changer for automatically registering and changing dies.

It is another object of the present invention to provide a system and method that automatically registers and changes dies without requiring “make-ready” operations.

It is a further object of the present invention to provide a system and method for changing dies with minimal effort and adjustments by an operator.

These and other objects of the present invention are obtained by providing a cone hole registration system for registering dies within a die changer. The die changer includes pins for locating cone holes associated with the die. In this manner, dies can be automatically registered and changed within the die changer.

### BRIEF DESCRIPTION OF THE DRAWINGS

These and other objects and advantages of the present invention will become apparent and more readily appreciated from the following detailed description of the presently preferred exemplary embodiments of the invention taken in conjunction with the accompanying drawings, of which:

FIG. 1 illustrates a perspective view of a die changer in accordance with the present invention;

FIG. 2 illustrates a more detailed perspective view of the die changer in accordance with the present invention;

FIG. 3 illustrates another detailed perspective view of the die changer in accordance with the present invention;

FIG. 4 illustrates a side view of the die changer in accordance with the present invention;

FIG. 5A illustrates a bottom view of the die with cone registration in accordance with the present invention; and

FIG. 5B illustrates a side view of the die with cone registration in accordance with the present invention.

### DETAILED DESCRIPTION OF THE PREFERRED EMBODIMENTS

The present invention will now be described in greater detail, which will serve to further the understanding of the preferred exemplary embodiments of the present invention. As described elsewhere herein, various refinements and substitutions of the various embodiments are possible based on the principles and teachings herein.

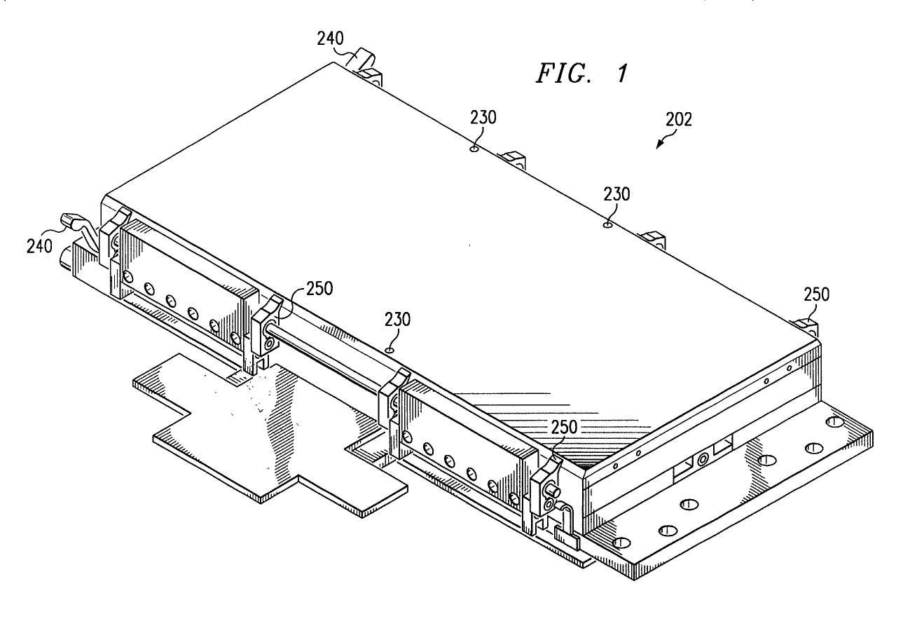

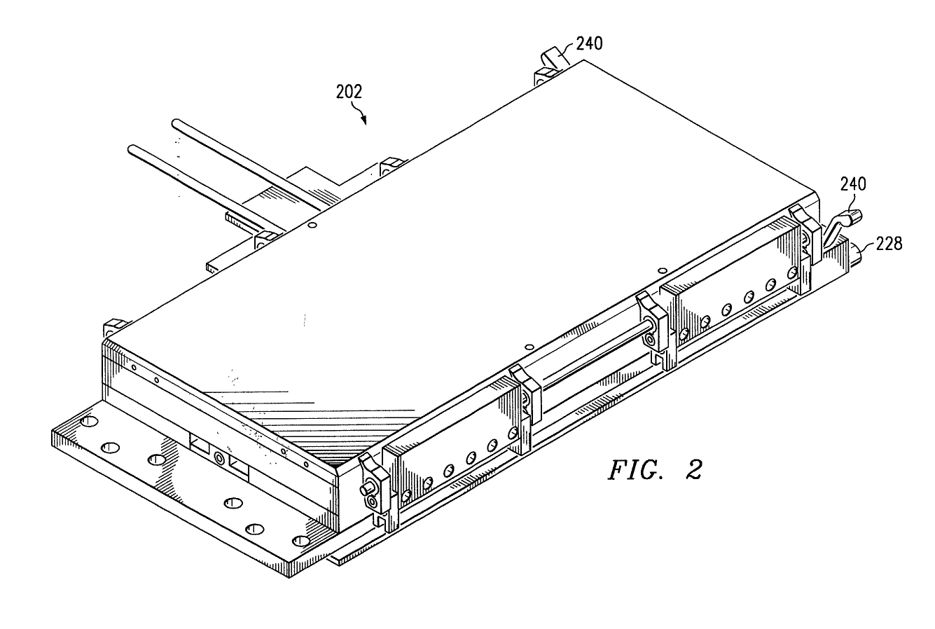

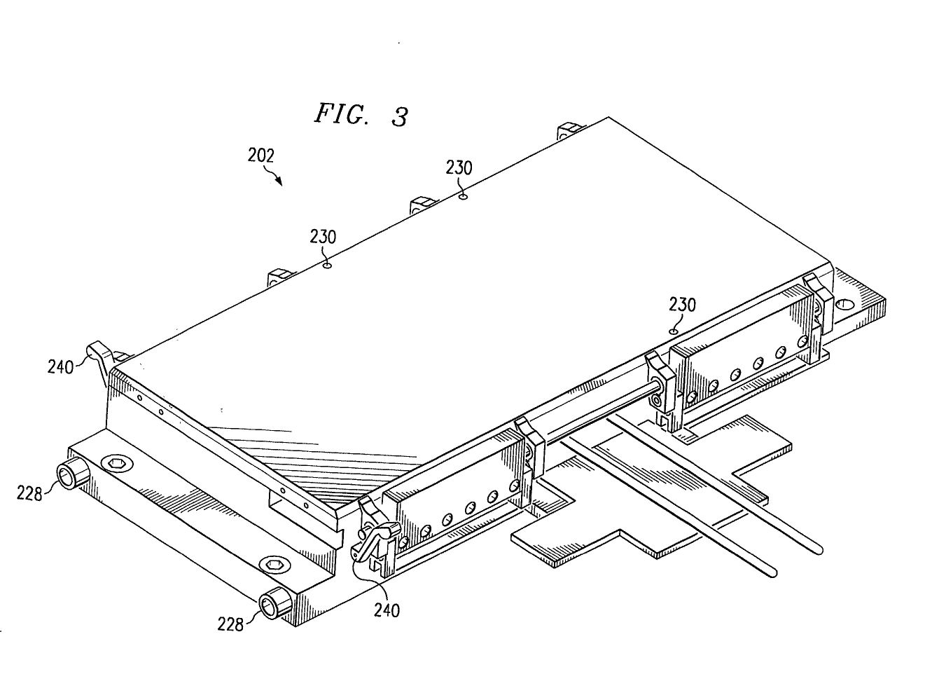

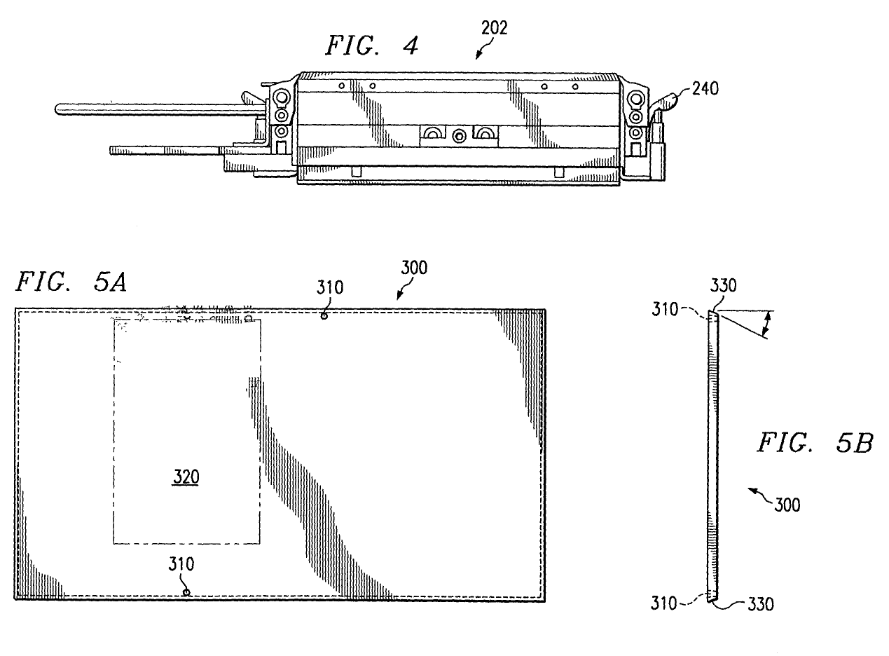

The preferred embodiments of the present invention will now be described with reference to FIGS. 1-5, wherein like components, steps, etc. are designated by like reference numerals throughout the various figures. Further, specific details and parameters are provided herein and are intended to be explanatory rather than limiting.

The present invention relates to a cone hole registration system for registering dies within a die changer. The die changer with pins located therein is used for registering and locking dies. The die changer of the present invention can be used in conjunction with the emboss module described in the co-pending U.S. patent application Ser. No. ______, Attorney Docket No. 34062/0272034, filed concurrently herewith, titled “Integrated Emboss Module,” and assigned to the common assignee of record.

In the following descriptions, it is understood that other components, devices, and parts than those described below may be substituted and are intended to be within the scope and spirit of the present invention. In addition, well known components, devices, functions, and the like will not be described in great detail since they are well known in the art.

FIGS. 1-4 illustrate various perspective views and a side view of a die changer in accordance with the present invention. Reference will be made concurrently to these figures for a more complete understanding of the present invention. As will be described in greater detail below, the die changer is used to automatically change die or dies during the embossing process. The dies are changed with minimal participation from an operator and without performing “make-ready” operations.

The die changer 202 includes pre-drilled holes mated with pins 230 therein. The die (see FIG. 5) includes beveled edges cut to allow toggle clamps 250 to hold the die within the die changer 202. The die changer 202 is registered into a swing arm (not shown) and shuttled into an emboss module. During operation, the die is positioned on the die changer 202 that is typically pre-heated.

The die changer 202 also includes cam followers 228 for registering into the emboss module. In this manner, automatic changing of the die can be performed with minimal interruption and no “make-ready” operations during the embossing process. The die changer 202 can be used for both emboss and foil dies. The die (see FIG. 5) is positioned on the die changer 202 by matching the pin holes 310 on the die 300 with the pins 230 on the die changer 202. In other words, the die is placed on the die changer 202 with pre-drilled locator pin holes mated with the pins 230 on the die changer 202. With the die registered to the pins 230 and nested flat, two toggle clamp thumb trigger levers 240 are used to release and lock the die therein. For example, when the trigger levers 240 are pushed in, the die will be released, and when the trigger levers 240 are pulled out, the die will be locked in the die changer 202. An emboss die includes beveled edges to allow the toggle clamps 250 to hold the die on the die changer 202.

The die changer 202 is pre-heated to a high temperature in order to heat the dies registered therein. For example, for emboss dies, the temperature is about 100-150 Fahrenheit, whereas for foil dies the temperature is about 245-265 Fahrenheit. The die changer 202 includes heater rods and insulators (i.e., ceramic) therein, as well known in the art.

FIG. 5A illustrates a bottom view and FIG. 5B illustrates a side view of the die with cone registration in accordance with the present invention. The die 300 includes complementary cone holes 310 for registering into the pins 230 of the die changer 202. An artistic image is shown in the hidden or dashed area 320 on the face side of the die 300. Any artistic image can be formed on the die 300, while the position of the cone holes 310 remain unchanged. In this manner, because the cone holes 300 are permanent fixtures on each die 300, automatic registering and changing of the die 300 on the die changer 202 is performed efficiently and quickly. In the side view illustrated in FIG. 5B, angled or beveled edge 330 fits into the toggle clamps 250 of the die changer 202 in a complementary manner.

The cone hole registration system described herein is designed to determine the location of the emboss dies by preparing a template to follow before the art is created, before the lithography is printed and before the emboss has a design position. A master template that matches predetermined paper size, die size and machine lock-up location is followed for precision targeting points. The targeting points correspond with cone hole pins on the die changer or emboss module. These are target cross hairs for engravers to mark and mechanical fixtures for tool holders to follow the engravers marks for locating, locking and drilling the cone holes in the die. The emboss die cone holes locate and mate onto the pins, and the die is secured in position by clamps or keys. Any process that leads embossing (paper target registration, material handling) or follows (adhesion and cutting registration) will have targeting relationships with the master template. The emboss die cone hole can also apply to the counter die half. The present invention can be used for multiple size panels, single panel triple panels, or multiple panels for gang impression.

Although various preferred embodiments of the present invention have been disclosed for illustrative purposes, those skilled in the art will appreciate that various modifications, additions and/or substitutions are possible without departing from the scope and spirit of the present invention as disclosed in the claims.

In the previous descriptions, numerous specific details and examples are set forth such as specific components, devices, steps, materials, temperatures, weights, etc., to provide a thorough understanding of the present invention. However, as one having ordinary skill in the art would recognize, the present invention can be practiced without resorting to the details and examples specifically set forth. Those skilled in the art will readily appreciate that many modifications of the exemplary embodiments are possible without materially departing from the novel teachings and advantages of this invention.

What is claimed:

1. A die changer for registering and releasing a die having a plurality of holes, the die changer comprising:
a die receiving surface having a plurality of pins extending therefrom, wherein the plurality of pins are adapted to fit into the plurality of holes; and
trigger levers for registering and releasing the die from the plurality of pins on the die changer.

2. A die changer according to claim 1 further comprising toggle clamps for holding the die within the die changer.

3. A die changer according to claim 1 further comprising heater rods and an insulator therein for heating the die.

4. A die changer according to claim 3, wherein the heater rods and the insulator are used to heat the die to about 100-150 Fahrenheit.

5. A die changer according to claim 3, wherein the heater rods and the insulator are used to heat the die to about 245-265 Fahrenheit.

6. A die changer according to claim 3, wherein the insulator comprises a ceramic material.

7. A die changer according to claim 1, wherein the die is registered into the plurality of pins when the trigger levers are pulled out.

8. A die changer according to claim 1, wherein the die is released from the plurality of pins when the trigger levers are pushed in.

9. A die changer according to claim 1 further comprising cam followers for registering into an emboss module.

10. A die changer registration system, comprising
a die having a plurality of holes and beveled edges; and
a die changer having trigger levers, trigger clamps, and a die receiving surface including a plurality of pins extending therefrom, wherein the plurality of pins are adapted to fit into the plurality of holes, and the trigger clamps are adapted to hold the die within the die changer using the beveled edges.

11. A die changer registration system according to claim 10, wherein the die changer further comprises heater rods and an insulator therein for heating the die.

12. A die changer registration system according to claim 11, wherein the heater rods and the insulator are used to heat the die to about 100-150 Fahrenheit.

13. A die changer registration system according to claim 11, wherein the heater rods and the insulator are used to heat the die to about 245-265 Fahrenheit.

14. A die changer registration system according to claim 11, wherein the insulator comprises a ceramic material.

15. A die changer registration system according to claim 10, wherein the die is registered into the plurality of pins when the trigger levers are pulled out.

16. A die changer registration system according to claim 10, wherein the die is released from the plurality of pins when the trigger levers are pushed in.

17. A die changer registration system according to claim 10, wherein the die changer further comprises cam followers for registering into an emboss module.

18. A die changer registration system according to claim 10, wherein the die comprises a face side with an artistic image formed thereon.

19. A die changer registration system according to claim 10, wherein the plurality of holes are formed in cone shape.

20. A die changer for registering and releasing a die having a plurality of holes, the die changer comprising
means for extending a plurality of pins from a die receiving surface;
means for registering the die onto the plurality of pins on the die changer using the plurality of holes; and
means for releasing the die from the plurality of pins on the die changer.

21. A die changer according to claim 20, wherein the means for registering and releasing the die includes trigger levers.

22. A die changer according to claim 21, wherein the die is registered into the plurality of pins when the trigger levers are pulled out.

23. A die changer according to claim 21, wherein the die is released from the plurality of pins when the trigger levers are pushed in.
